(19) United States
(12) Patent Application Publication
(10) Pub. No.: US 2025/0125531 A1
(43) Pub. Date: Apr. 17, 2025

(54) CAVITY BACKED DIPOLE ANTENNA WITH REDUCED CAVITY SIZE

(71) Applicant: BAE SYSTEMS Information and Electronic Systems Integration Inc., Nashua, NH (US)

(72) Inventor: Dean W. Howarth, Sudbury, MA (US)

(73) Assignee: BAE SYSTEMS Information and Electronic Systems Integration Inc., Nashua, NH (US)

(21) Appl. No.: 18/486,425

(22) Filed: Oct. 13, 2023

(51) Int. Cl. H01Q 13/18; H01Q 1/42

(52) U.S. Cl. CPC H01Q 13/18; H01Q 1/422

(57) ABSTRACT

A cavity backed antenna assembly includes a conductive lower wall and two or more conductive side walls at least in part defining a cavity. The antenna assembly further includes a first layer and a second layer each including a first dielectric material above the lower wall and within the cavity, and a third layer including a second dielectric material between and separating the first and second layers. In an example, the second dielectric material compositionally different from the first dielectric material. The antenna assembly further includes a first conductive structure and a second conductive structure separated by a third dielectric material, wherein the first conductive structure and the second conductive structure are within the cavity and above the first and second layers. In an example, the first dielectric material a relative magnetic permeability of at least 1 for a frequency between 10 MHz and 1 GHz.

### FIELD OF DISCLOSURE

The present disclosure relates to antennas, and more particularly, to cavity backed dipole antenna structures.

### BACKGROUND

An antenna transduces electromagnetic (EM) waves to radio frequency (RF) electrical signals. Antennas can provide wideband and ultra-wideband operations, such as in conjunction with radar and tracking systems, high data rate communication links, and multi-waveform, multi-function front end systems. There remain a number of non-trivial challenges with respect to designing and manufacturing antenna structures.

### BRIEF DESCRIPTION OF THE DRAWINGS

FIGS. 1A, 1B, 1C, 1D, and 1E illustrate various views of a cavity backed dipole antenna structure, wherein a plurality of layers of dielectric material are within a lower cavity of the antenna structure, in accordance with an embodiment of the present disclosure.

FIG. 1F illustrates a plan view of a plurality of conductive structures extending between opposing walls of the lower cavity of the antenna structure of FIGS. 1A-1E, in accordance with an embodiment of the present disclosure.

FIG. 1F1 illustrates a plan view of a plurality of conductive structures extending between opposing walls of the lower cavity of the antenna structure of FIGS. 1A-1E, in accordance with another embodiment of the present disclosure.

FIGS. 2A and 2B each illustrates a plan view of a layer of dielectric material within a lower cavity of the antenna structure of FIGS. 1A-1E, in accordance with another embodiment of the present disclosure.

FIG. 3 illustrates a cross-sectional view of a cavity backed dipole antenna structure wherein a plurality of layers of dielectric are within a lower cavity of the antenna structure, in accordance with another embodiment of the present disclosure.

FIG. 4 illustrates the cavity backed dipole antenna structure of FIGS. 1A-1E, with a dielectric spacer between the upper layer of dielectric material and the conductive structures comprising the dipole arms, in accordance with an embodiment of the present disclosure.

FIG. 5 illustrate a flowchart depicting a method of forming an example a cavity backed dipole antenna structure (such as any of the antenna assemblies described above), in accordance with an embodiment of the present disclosure.

FIGS. 6A, 6B, and 6C collectively illustrate an example antenna assembly in various stages of processing in accordance with the methodology of FIG. 5, in accordance with an embodiment of the present disclosure.

Although the following detailed description will proceed with reference being made to illustrative examples, many alternatives, modifications, and variations thereof will be apparent in light of this disclosure.

### DETAILED DESCRIPTION

Cavity backed dipole antenna structures are disclosed. In an example, a cavity of the antenna structure includes a plurality of layers of a first dielectric material that are stacked above a lower conductive plate, wherein any two adjacent layers of the first dielectric material are separated by a second dielectric material that is compositionally different from the first dielectric material. In an example, the first dielectric material has relatively high relative magnetic permeability in the frequency range of interest and/or the second material has relatively low dielectric constant (where example ranges of the relative magnetic permeability and dielectric constant are described below). The relatively high relative magnetic permeability of the first dielectric material, along with a relatively low dielectric constant of the second dielectric material. allows reduction of dimensions of the cavity (such as a Z-axis height of the cavity), without corresponding sacrifice in one or more parameters of interest (such as gain and bandwidth) of the antenna structure, which resultantly allows a smaller size and/or lower weight of the antenna structure.

In one embodiment, a cavity backed antenna assembly comprises a conductive lower wall and two or more conductive side walls at least in part defining a cavity. The assembly further includes a first layer and a second layer each comprising a first dielectric material above the lower wall and within the cavity, and a third layer comprising a second dielectric material between and separating the first and second layers. In an example, the second dielectric material is compositionally different from the first dielectric material. In an example, the first dielectric material has a relative magnetic permeability of at least 1.0, at least 1.5, or at least 1.8, or at least 2, or at least 2.5, or at least 3, or at least 5, or at least 7, or at least 10, or at least 12, e.g., for the frequency range of interest (which may be between about 10 MHz to about 1 GHz, for example). In an example, the first dielectric material has a magnetic loss tangent of at most 1.5, or at most 1.2, or at most 1, or at most 0.9, or at most 0.75, or at most 0.6, or at most 0.5, e.g., for the frequency range of interest (which may be about 10 MHz to about 1 GHZ, for example). In an example, the second dielectric material comprises dielectric foam material, and a dielectric constant of at most 1.05, or at most 1.10, at most 1.2, at most 1.5, at most 1.8, or at most 2. The antenna assembly further includes a first conductive structure and a second conductive structure separated by a third dielectric material, wherein the first conductive structure and the second conductive structure are within the cavity and above the first and second layers. In an example, the first and second conductive structures are dipole arms of the antenna assembly.

In another example embodiment, a method of manufacturing an antenna assembly comprises manufacturing (i) a plurality of conductive sidewalls of a cavity, and (ii) a cross-shaped structure. The cross-shaped structure includes a first dielectric material that extends from a first conductive sidewall to an opposing second conductive sidewall, and also from a third conductive sidewall to an opposing fourth conductive sidewall. In an example, a plurality of sections of the cross-shaped structure are plated with conductive material to respectively form a plurality of dipole arms. The method further comprises forming a lower conductive plate defining a floor of the cavity, and forming (i) a first layer and a second layer each comprising a second dielectric material above the lower conductive plate and within the cavity and (ii) a third layer comprising a third dielectric material between and separating the first and second layers. In an example, the second dielectric material is compositionally different from the third dielectric material. The method further comprises manufacturing a ground plane comprising conductive material, with an opening therewithin, and placing an upper layer comprising a fourth dielectric material within the opening. the upper layer of fourth dielectric material defining a ceiling or upper surface of the cavity. In an example, manufacturing the plurality of conductive sidewalls and the ground plane comprises manufacturing, using a three-dimensional (3D) printing process, the plurality of conductive sidewalls of the cavity and/or the ground plane. Numerous configurations and variations will be apparent in light of this disclosure.

### General Overview

As mentioned herein above, there remain a number of non-trivial challenges with respect to designing and manufacturing antenna assemblies. For example, a cavity backed antenna structure comprises a cavity defined by conductive sidewalls and a conductive lower wall (e.g., a floor of the cavity). In such an antenna structure, the cavity is excited using two or more conductive dipole arms within the cavity. Such cavity backed antenna structures tend to have a relatively large size, e.g., to achieve desired parameters of interest (such as desired gain and bandwidth). One possible solution is to reduce the cavity size. However, merely reducing the size of the cavity may result in degradation of the desired parameters of interest.

Accordingly, techniques are described herein to form a cavity backed dipole antenna structure, which comprises a plurality of layers of first dielectric material stacked above a lower conductive plate of a cavity of the antenna structure, where any two adjacent layers of the first dielectric material are separated by a second dielectric material that is compositionally different from the first dielectric material. In an example, the first dielectric material has relatively high relative magnetic permeability in the frequency range of interest and/or the second dielectric material has relatively low dielectric constant. In an example, the first dielectric material has a relative magnetic permeability of at least 1.5, or at least 1.8, or at least 2, or at least 2.5, or at least 3, or at least 5, or at least 7, or at least 10, or at least 12, e.g., for the frequency range of interest (which may be about 10 MHz to about 1 GHZ, for example). In an example, the first dielectric material has a magnetic loss tangent of at most 1.5, or at most 1.2, or at most 1, or at most 0.9, or at most 0.75, or at most 0.6, or at most 0.5, e.g., for the frequency range of interest (which may be about 10 MHz to about 1 GHz, for example). In an example, the second dielectric material comprises dielectric foam material, and a dielectric constant of at most 1.05, or at most 1.10, at most 1.2, at most 1.5, at most 1.8, or at most 2. In an example, the second dielectric material comprises a dielectric foam material. The high relative magnetic permeability of the first dielectric material, along with a relatively low dielectric constant of the second dielectric material, allows reduction of dimensions of the cavity (such as a Z-axis height of the cavity), without corresponding sacrifice in one or more parameters of interest (such as gain and bandwidth) of the antenna structure, which resultantly allows a smaller size and/or lower weight of the antenna structure. Given the relatively smaller footprint of the antenna structure, it may be readily used to retrofit (replace) a larger conventional antenna structure, because it relatively small form factor allows the antenna structure to be placed within the space or location previously occupied by the relatively larger conventional structure.

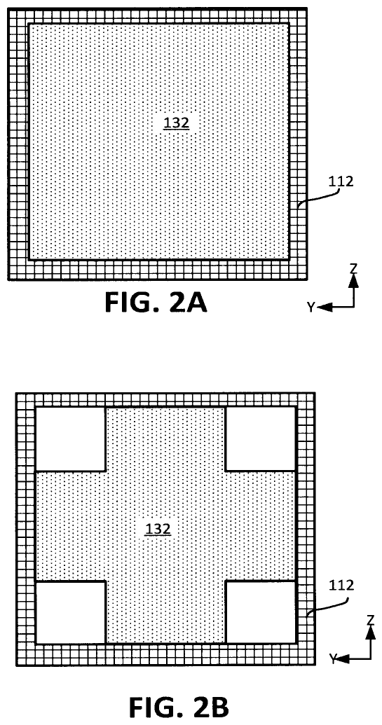

In one embodiment, the plurality of layers of first dielectric material may be shaped to further reduce a weight of the antenna structure. For example, each layer of the plurality of layers of first dielectric material may be rectangular, e.g., see FIG. 2A. However, in an example, electromagnetic fields of the antenna structure may not reach the corners of the cavity, and hence, portions of the plurality of layers of first dielectric material in the corners may not substantially contribute to achieving the antenna parameters of interest. Thus, according to an embodiment of the present disclosure, the corners of the dielectric layers can be eliminated, without adversely impacting antenna performance. Accordingly, in an example, each layer of the plurality of layers of first dielectric material may be cross-shaped, as illustrated in FIG. 2B. Thus, such shape-tailoring of the plurality of layers of first dielectric material results in reduction in the weight of the antenna structure (e.g., compared to a scenario where rectangular shaped layers are used, such as in FIG. 2A).

In one embodiment, the antenna structure comprises a lower conductive wall, which forms a floor of the cavity. The above described plurality of layers of the first dielectric material, interleaved with the second dielectric material, is above and on the lower conductive wall. The walls of the cavity comprise conductive structures.

The cavity of the antenna structure is partitioned into a lower cavity and an upper cavity, and the two cavities are interconnected. In an example, the antenna structure comprises a cross-shaped structure of dielectric material, such as a cross-shaped cut out of a printed circuit board (PCB) material, a laminate, a resin, FR4, porcelain, mica, glass, plastics, and/or other appropriate dielectric materials used in a PCB. A section of the cavity below the cross-shaped structure of dielectric material is referred to as the lower cavity, and another section of the cavity above the cross-shaped structure of dielectric material is referred to as the upper cavity, where the lower and upper cavities are interconnected through openings within the cross-shaped structure of dielectric material.

In one embodiment, the cross-shaped structure of dielectric material extends from a first vertical wall of the lower cavity to an opposing second vertical wall of the lower cavity, and also extends from a third vertical wall of the lower cavity to an opposing fourth vertical wall of the lower cavity. One or more metals and/or alloys thereof are plated or otherwise deposited selectively on a plurality of locations of the cross-shaped structure of dielectric material, to respectively form a plurality of dipole arms of the antenna structure. In one embodiment, no one dipole arm is in contact with an adjacent dipole arm.

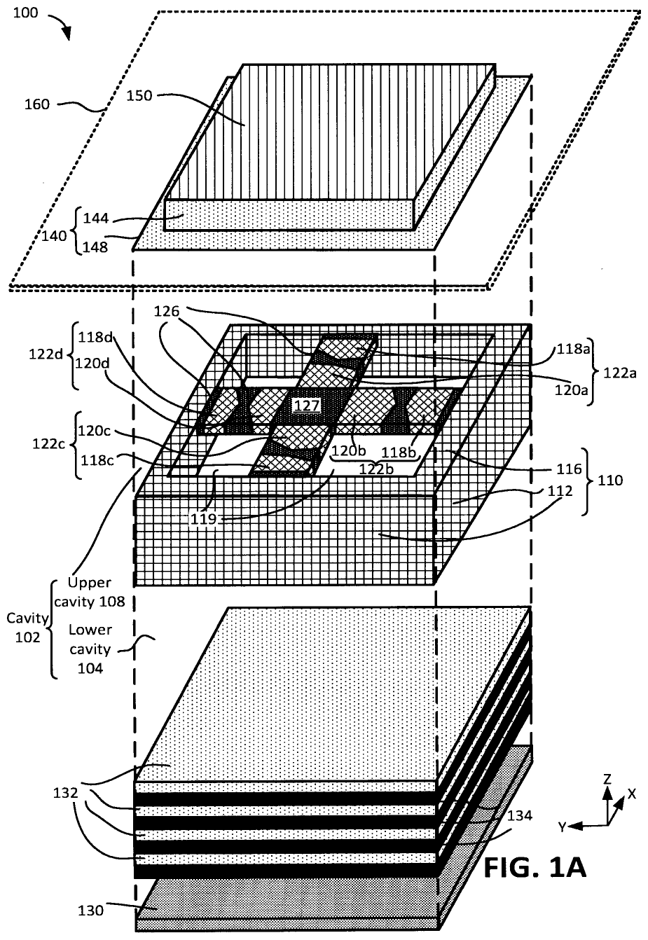

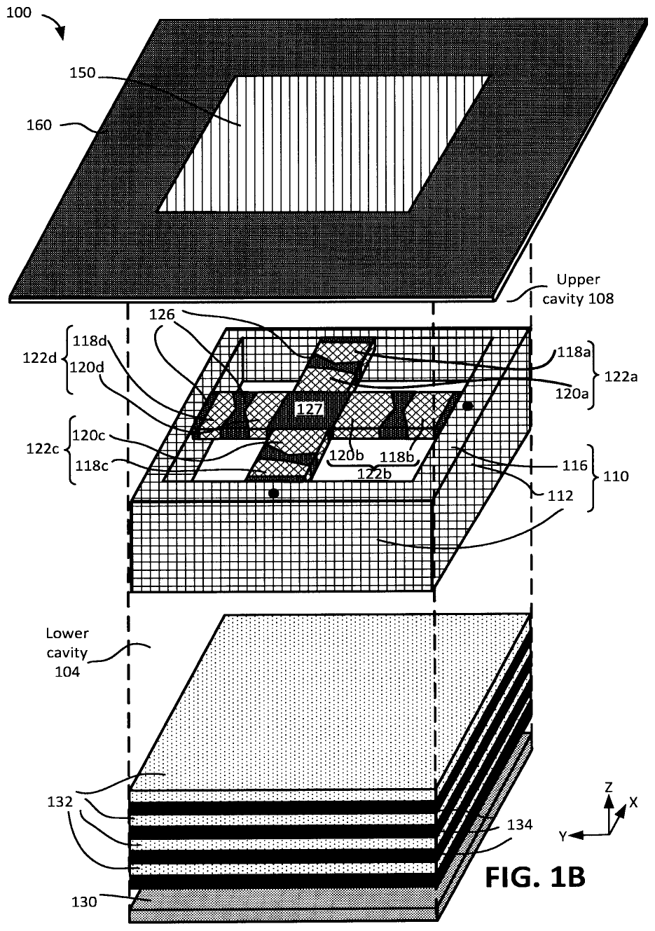

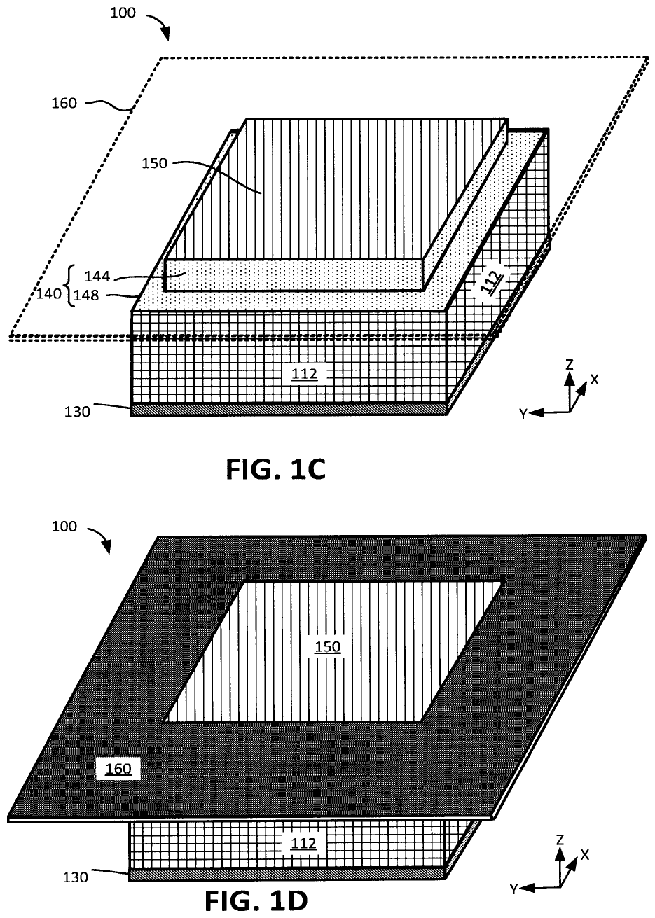

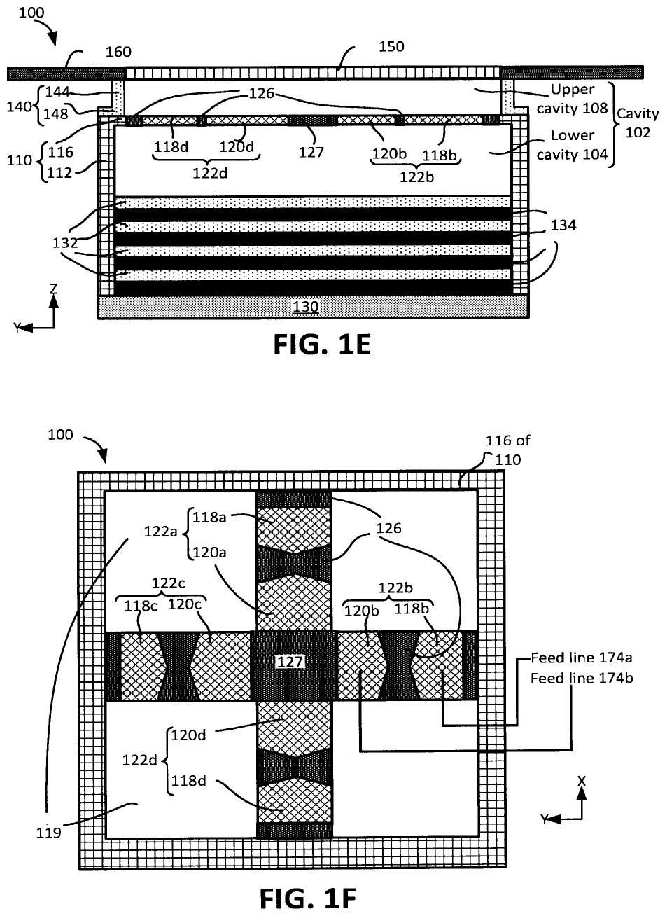

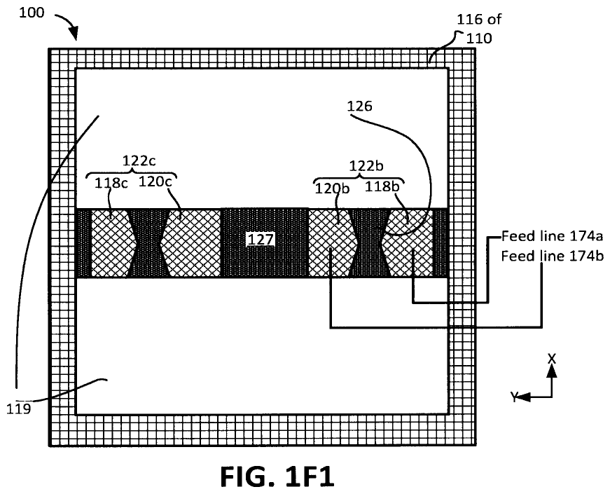

In an example, the cross-shaped structure of dielectric material allows for formation of four pairs of dipole arms (e.g., a total of eight dipole arms), e.g., see FIG. 1F. Note that the cross-shaped structure of dielectric material (and corresponding locations of the dipole arms) is merely an example, and the shape and structure of dielectric material and corresponding locations/number of the dipole arms can be different. For example, FIG. 1F1 illustrates a single bar-like shape of the structure of dielectric material and two corresponding pairs of dipole arms. In some examples, each dipole arm is connected to a corresponding feed line. In one such example, the feed lines excite the corresponding dipole arms, causing the dipole arms to form the radiating elements of the cavity backed dipole antenna structure.

In one embodiment, a layer comprising conductive material is also on the vertical walls of the antenna structure. In one embodiment, the layer acts as a ground plane of the antenna structure. In an example, the layer has an opening, through which an upper layer of dielectric material extends. The upper layer of dielectric material forms a ceiling or upper surface of the cavity. In an example, upper layer of dielectric material is a radome, through which the antenna waves radiate out of the cavity.

Example processes of manufacturing the antenna structure are also described below. In an example, the conductive sidewalls and the ground plane may be manufactured using an additive manufacturing process, such as a three-dimensional (3D) printing process. In such an example, the conductive sidewalls may form a continuous and monolithic structure, e.g., without any interface (such as a scam) between any portions of the continuous and monolithic structure. Similarly, the conductive sidewalls and the ground plane may also be continuous and monolithic. Numerous configurations and variations will be apparent in light of this disclosure.

Materials that are “compositionally different” or “compositionally distinct” as used herein refers to two materials that have different chemical compositions. This compositional difference may be, for instance, by virtue of an element that is in one material but not the other (e.g., copper is compositionally different than an alloy of copper), or by way of one material having all the same elements as a second material but at least one of those elements is intentionally provided at a different concentration in one material relative to the other material (e.g., two copper alloys each having copper and tin, but with different percentages of copper, are also compositionally different). If two materials are elementally different, then one of the materials has an element that is not in the other material (e.g., pure copper is elementally different than an alloy of copper).

It should be readily understood that the meaning of “above” and “over” in the present disclosure should be interpreted in the broadest manner such that “above” and “over” not only mean “directly on” something but also include the meaning of over something with an intermediate feature or a layer therebetween. As will be appreciated, the use of terms like “above” “below” “beneath” “upper” “lower” “top” and “bottom” are used to facilitate discussion and are not intended to implicate a rigid structure or fixed orientation; rather such terms merely indicate spatial relationships when the structure is in a given orientation.

### Architecture

FIGS. 1A and 1B illustrate exploded views, FIGS. 1C and 1D illustrate perspective views, and FIG. 1E illustrates a cross-sectional view of a cavity backed dipole antenna structure 100 (also referred to herein as an antenna structure 100, or simply as an antenna 100), wherein a plurality of layers 132, 134 of dielectric material are within a lower cavity 104 of the cavity backed dipole antenna structure 100, in accordance with an embodiment of the present disclosure.

In the exploded view of FIG. 1A and the cross-sectional view of FIG. 1C, a ground plane 160 of the antenna 100 is illustrated in a transparent fashion and using dotted lines, to make visible various components below the ground plane 160 (such as conductive structure 140), although the ground plane 160 need not be transparent in actual implementation. In the exploded view of FIG. 1B and the cross-sectional view of FIG. 1D, the ground plane 160 of the antenna 100 is illustrated as being opaque, such that one or more components below the ground plane 160 are not visible in these figures.

Referring to FIGS. 1A-1E, the antenna 100 includes a cavity 102, where the cavity 102 has two sections, such as a lower cavity 104 and an upper cavity 108 (e.g., see FIG. 1E). Note that the lower and upper cavities 104, 108 are interconnected through openings within various dipole arms 122, and thus may be considered as a single common cavity 102 of the antenna 100.

The lower cavity 104 is defined by a lower conductive plate 130, which forms a lower surface or a floor of the lower cavity 104. The conductive plate 130 comprises one or more metals and/or alloys thereof. In an example, the conductive plate 130 comprises a non-metal coated with one or more metals and/or alloys thereof.

The antenna 100 comprises a conductive structure 110 that includes a horizontal portion 116 and one or more vertical walls 112. As illustrated, the horizontal portion 116 extends from an upper portion of the vertical walls 112. In an example, the conductive structure 110 comprises one or more metals and/or alloys thereof. In an example, the conductive structure 110 comprises a non-metal coated with one or more metals and/or alloys thereof. Note that the horizontal portion 116 of the conductive structure 110 is not visible in FIGS. 1C and 1D, as the horizontal portion 116 in these figures are covered by other component(s) of the antenna 100.

As illustrated in the cross-sectional view of FIG. 1E, in one embodiment, the vertical walls 112 of the conductive structure 110 form the sidewalls of the lower cavity 104. Thus, the vertical walls 112 of the conductive structure 110 and the conductive plate 130, in combination, define the floor and walls of the lower cavity 104. The vertical walls 112 are on four sides of the lower cavity 104, in an example.

In an example, the horizontal portion 116 has an opening therewithin, and one or more conductive structures 122 are within this opening. FIG. 1F illustrates a plan view of the plurality conductive structures 122 within an opening formed by the horizontal portion 116 of the conductive structure 110, in accordance with an embodiment of the present disclosure. Note that the conductive structures 122 are not visible in the perspective views of FIGS. 1C and 1D, for being covered by the vertical walls 112 of the conductive structure 110.

Referring to FIGS. 1A-1F (and specifically to FIGS. 1A, 1B, 1E, and 1F), the antenna 100 comprises four pairs of conductive structures 122a, 122b, 122c, and 122d. Each conductive structure 122 comprises two corresponding pairs of dipole arms 118 and 120, in an example. Although four such pairs of dipole arms are illustrated in FIGS. 1A-1F, the antenna 100 may include a lower, or a higher, number of such pairs of dipole arms.

The conductive structure 122a comprises a dipole arm 118a and another dipole arm 122b, which are also conductive structures, and which are separated by dielectric material 126. Similarly, the conductive structure 122b comprises a dipole arm 118b and another dipole arm 122b, which are also conductive structures, and which are separated by dielectric material 126. Similarly, the conductive structure 122c comprises a dipole arm 118c and another dipole arm 122c, which are also conductive structures, and which are separated by dielectric material 126. Finally, the conductive structure 122d comprises a dipole arm 118d and another dipole arm 122d, which are also conductive structures, and which are separated by dielectric material 126.

In one embodiment, the conductive structures 122a, 122b, 122c, and 122d are separated from each other by dielectric material 127, which is at a location that is between the conductive structures 122aa, 122b, 122c, and 122d. Thus, any of the dipole arms 118a, 118b, 118, 118d, 120a, 120b, 120c, 120d are separated from another of the dipole arms 118a, 118b, 118, 118d, 120a, 120b, 120c, 120d (also referred to generally as dipole arms 118, 120) by corresponding dielectric materials 126 and/or 127. Thus, no two dipole arms are in contact with each other.

In one embodiment, the dipole arms 118a, 118b, 118, 118d are also separated from the horizontal portion 116 of the conductive structure 110 by corresponding dielectric material 126. Thus, the dipole arms 118a, 118b, 118, 118d are not in contact with the horizontal portion 116 of the conductive structure 110. The dipole arms 118a, 118b, 118, 118d are attached to the horizontal portion 116 through the corresponding dielectric materials 126 (without making contact with the horizontal portion 116), and are supported by the horizontal portion 116.

Thus, as illustrated in the plan view of FIG. 1F, the conductive structures 122a and 122d (e.g., comprising the conductive structures 118a, 120a, 120d, 118d) extend from one vertical wall of the lower cavity 104 to an opposing vertical wall of the lower cavity 104, where each conductive structure is separated from an adjacent conductive structure and/or from the vertical walls of the lower cavity 104 by a corresponding section of the dielectric material 126. Similarly, the conductive structures 122c and 122b (e.g., comprising the conductive structures 118c, 120c, 120b, 118b) extend from one vertical wall of the lower cavity 104 to an opposing vertical wall of the lower cavity 104, where each conductive structure is separated from an adjacent conductive structure and/or from the vertical walls of the lower cavity 104 by a corresponding section of the dielectric material 126.

As illustrated, the dipole arms 118, 120 are above the layers 130, 134 of dielectric materials, and define an upper surface or ceiling (or roof or upper surface) of the lower cavity 104. The dipole arms 118, 120 also define a lower surface or floor of the upper cavity 108. In an example, the dipole arms 118, 120 have openings therethrough, such as openings 119 labelled in FIGS. 1A and 1F. The lower cavity 104 and the upper cavity 108 are interconnected through the openings 119 within the dipole arms 118, 120.

In one embodiment, the dipole arms 118a, 118b, 118, 118d, 120a, 120b, 120c, 120d comprise conductive material, such as one or more metals and/or alloys thereof. In an example, the dipole arms 118, 120 comprise a non-metal component plated by one or more metals and/or alloys thereof.

In one example, the dielectric materials 126, 127 and the interior of the dipole arms 118, 120 comprise a cross-shaped structure of dielectric material, such as a cross-shaped cut out of a printed circuit board (PCB) material, a laminate, a resin, FR4, porcelain, mica, glass, plastics, and/or other appropriate dielectric materials used in a PCB. The cross-shaped structure of dielectric material extends from a first vertical wall of the lower cavity 104 to an opposing second vertical wall of the lower cavity 104, and also extends from a third vertical wall of the lower cavity 104 to an opposing fourth vertical wall of the lower cavity 104. One or more metals and/or alloys thereof are plated or otherwise deposited selectively on a plurality of locations of the cross-shaped structure of dielectric material, to respectively form the plurality of dipole arms 118, 120.

Referring again to FIG. 1F, illustrated is the plan view of the plurality conductive structures 122, including the dipole arms 118 and 120. Each dipole arm 118a, 118b, 118c, 118d, 120a, 120b, 120c, 120d is connected to a corresponding feed line 174. For example, the dipole arm 118b is connected to a corresponding feed line 174a, and the dipole arm 120b is connected to a corresponding feed line 174b. Other dipole arms are also connected to corresponding feed lines, although not illustrated in FIG. 1F. Note that in FIG. 1F, the connections between each feed line 174 and a corresponding dipole arm 118 or 120 is illustrated schematically, and the structure of actual connection may be implementation specific. In one embodiment, the feed lines 174 excite the dipole arms 118, 120, causing the dipole arms 118, 120 to form the radiating elements of the cavity backed dipole antenna structure 100.

FIG. 1F1 illustrates a plan view of the plurality of conductive structures 122 within the opening formed by the horizontal portion 116 of the conductive structure 110, in accordance with another embodiment of the present disclosure. As shown in the example of FIG. 1F1, conductive structure 122b comprising dipole arms 118b, 120b and conductive structure 122c comprising dipole arms 118c, 120c (e.g., a total of two pairs of dipole arms) are present in the antenna structure 100. In contrast, in the example shown in FIG. 1F, four such pairs of dipole arms are present. The above relevant description with respect to FIG. 1F is equally applicable to the description of FIG. 1F1.

In one embodiment, the antenna 100 comprises a conductive structure 140 above the conductive structure 110. The conductive structure 140 comprises a horizontal portion 148 and one or more vertical walls 144. As illustrated, the horizontal portion 148 extends from a lower portion of the vertical walls 144. In an example, the conductive structure 140 comprises one or more metals and/or alloys thereof. In an example, the conductive structure 140 comprises a non-metal coated with one or more metals and/or alloys thereof. Note that the conductive structure 140 is not visible in FIGS. 1B and 1D, for being covered by other component(s) of the antenna 100.

As illustrated in the cross-sectional view of FIG. 1E, in one embodiment, the vertical walls 144 of the conductive structure 140 form the sidewalls of the upper cavity 108. The vertical walls 144 are on four sides of the upper cavity 108.

In one embodiment, the horizontal portion 148 of the conductive structure 140 sits at least in part on the horizontal portion 116 of the conductive structure 110. For example, the horizontal portions 116 and 148 are mechanically attached to each other (e.g., using screws, or nuts, or other attachment structures), or form a continuous and monolithic structure of conductive material. The horizontal portion 116 mechanically supports the conductive structure 140 above the conductive structure 110.

In an example, the vertical walls 144 has an opening on an upper portion of the walls 144, and a dielectric material 150 extends through this opening. In an example, the dielectric material 150 forms a ceiling or roof of the upper cavity 108 (see FIG. 1E, for example). In an example, the dielectric material 150 is attached to, or at least above, an upper portion of the vertical walls 144. In an example, the dielectric material 150 forms a radome of the antenna 100.

In one embodiment, a layer 160 comprising conductive material is also on the vertical walls 144 of the conductive structure 140. The layer 160 has an opening, through which the dielectric material 150 extends. Note that in FIG. 1E, the opening of the layer 160 and the opening of the structure 140 coincides, although this may not necessarily be the case, and one of the two openings may be different in size from the other of the two openings.

In an example, the layer 160 comprises one or more metals and/or alloys thereof, such as aluminum, copper, and/or another appropriate metal. In an example, the layer 160 comprises a non-metal coated with one or more metals and/or alloys thereof. In yet another example, the layer 160 comprises metal embedded within a non-metal, such as a copper mesh embedded within a carbon fiber board. As illustrated, a horizontal dimension of the layer 160 (e.g., along the X and/or Y axes labelled in various figures) is more than a horizontal dimension of the structures 110 and/or 140. Thus, portions of the layer 160 do not have any other component of the antenna 100 underlying those portions, e.g., see FIG. 1E. In one embodiment, the layer 160 acts as a ground plane of the antenna 100.

In one embodiment, the antenna 100 further comprises a first plurality of layers 132 of dielectric material and a second plurality of layers 134 of dielectric material, where the layers 134 and 134 are interleaved with each other to form a stack of alternating layers. The stack of layers 132, 134 are arranged within a lower section of the lower cavity 104. For example, the stack of layers 132, 134 are on the lower conductive plate 130.

FIGS. 2A and 2B each illustrates a plan view of a layer 132 of dielectric material within the lower cavity 104 of the antenna structure 100 of FIGS. 1A-1E, in accordance with another embodiment of the present disclosure. In FIGS. 2A and 2B, illustrated is one of the layers 132 of FIGS. 1A-1E, and the vertical walls 112 of the conductive structure 100.

Note that in FIGS. 1A-1E, there are a plurality of the layers 132. FIG. 2A illustrates a single one of the layers 132, and other ones of the layers 132 may have the same cross-sectional shape as the layer 132 illustrated in FIG. 2A. Similar description also applies to the example of FIG. 2B.

Referring to the plan view of FIG. 2A, a cross-section of the layer 132 has a substantially rectangular or square shape. For example, the layer 132 extends from a first one of walls 112 to an opposing second one of walls 112, and also extends from a third one of walls 112 to an opposing fourth one of walls 112, without an opening between the layer 132 and the walls 112. For example, substantially an entirety of a horizontal plane within the lower cavity 104 is filled with or occupied by the layer 132.

In contrast, referring to the plan view of FIG. 2B, a cross-section of the layer 132 has a cross-like (or a “+” like) shape. In such an example, the corner sections of the lower cavity 104 are not occupied by the layer 132. Thus, there are four openings between the layer 132 and the walls 112. Other examples may be configured differently, such as one out of four corners being open, or two out of four corners being open, or three out of four corners being open, or some other shape or pattern of openings.

Thus, for example, a layer 132 (and/or a layer 134) is completely within a portion of the lower cavity 104, where the portion of the lower cavity 104 has a maximum length, a maximum width, and a maximum cross-sectional area based on the maximum length and maximum width. The layer 132 (and/or the layer 134) occupies only a portion of the maximum cross-sectional area. For example, the layer 132 (and/or the layer 134) occupies 50% to 75% (or 50% to 80%, or 50% to 90%) of the maximum cross-sectional area. In an example, the cavity 104 has a cross-sectional area, and the layer 132 (and/or a layer 134) is shaped to reduce the amount of the cross-sectional area it occupies.

In an example, electrical fields of the antenna 100 are primarily concentrated in an area that has a cross-like shape. For example, the corners of the cavity 104 have relatively less, or substantially zero electrical field, during operation of the antenna 100. Accordingly, presence of layer 132 at or near the corners contributes little or nothing to the parameters of interest of the antenna 100 (such as gain and bandwidth). Accordingly, the shape of layer 132 can be tailored to match or otherwise exploit the cross-like shape of the electrical fields. In one such example, layer 132 has the cross-like shape in FIG. 2B, which results in decreased area of the layer 132, which in turn results in a decrease in a weight and/or cost for the layer 132. Note that such savings in weight and/or cost scales based on the number of layers 132 of the antenna 100, assuming layer each has substantially the same shape or an otherwise tailored or reduced shape, relative to a whole (unreduced) layer 132.

Referring again to FIGS. 1A-1E, in one embodiment, the layers 132 comprise a first dielectric material and the layers 134 comprise a second dielectric material, where the first and second dielectric materials are elementally and compositionally different.

In an example, the dielectric material of the layers 134 comprise an appropriate dielectric material having relatively low dielectric constant, such as a dielectric constant of at most 1.05, or at most 1.10, at most 1.2, at most 1.5, at most 1.8, or at most 2, or at most 2.5, for example. For example, the dielectric constant of the dielectric material of the layers 134 is as close to 1 (which is the dielectric constant of air) as possible. In an example, a dielectric foam material is used, such as a dielectric foam having air bubbles introduced therewithin (e.g., to reduce the dielectric constant). Merely as an example, a polymethacrylimide (PMI) based structural foam, such as ROHACELL® (available commercially from Evonik® Industries, Germany), may be used. In another example, another appropriate dielectric material may be used, such as another appropriate type of dielectric foam. In yet another example, space between adjacent layers 132 may be kept blank (e.g., the layer 134 in this case is simply air). In such an example, the layers 132 may be affixed to the walls 112, or offset from each other by a number (e.g., three to six) relatively small but structurally sound dielectric posts.

In FIGS. 1A, 1B, and 1E, the layers 134 have substantially the same cross-sectional dimensions (e.g., X-Y axis dimensions) as the layers 132. However, in an example, the layers 134 may have different cross-sectional dimensions and shape than the layers 132. For example, while the layers 132 may be cross-shaped (as illustrated in FIG. 2B), the layers 134 may be rectangular (e.g., different from the layers 132) or may be cross-shaped (e.g., same as the layers 132). In another example, both layers 132 and 134 may be substantially rectangular or square (e.g., see FIG. 2A).

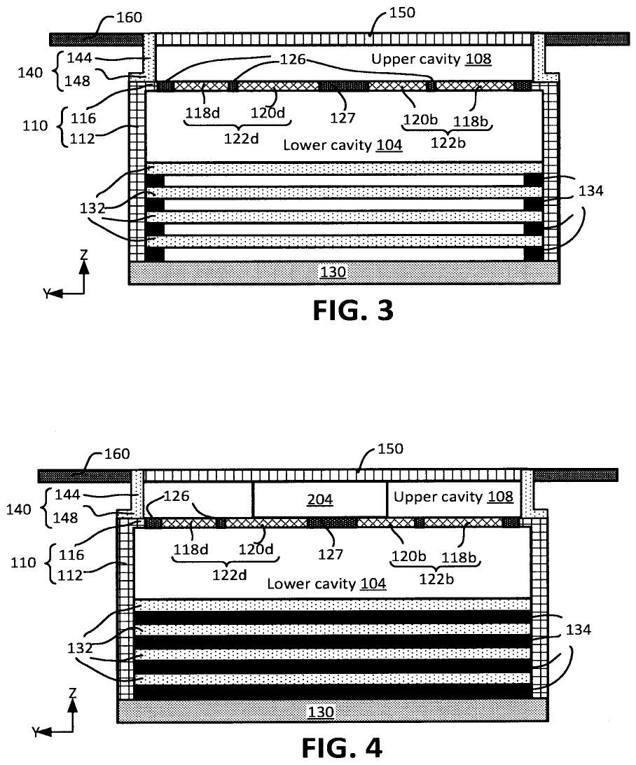

FIG. 3 illustrates a plurality of layers 134 of dielectric material that are within a lower cavity 104 of the antenna structure 100 of FIGS. 1A-1E, in accordance with another embodiment of the present disclosure. For example, as illustrated in FIGS. 1A-1E, the layers 134 of dielectric material extend from a first wall of the lower cavity 104 to an opposing second wall of the lower cavity 104, and also from a third wall of the lower cavity 104 to an opposing fourth wall of the lower cavity 104. In contrast, in the cross-sectional view of FIG. 3, individual ones of the layers 134 have a shape of a washer, e.g., a small piece of dielectric material separating two adjacent layers 132. The shape of the layers 134 in FIG. 3 decreases a net weight of the antenna 100, and decreases an effective dielectric constant of the stack of layers 134, 132, while maintaining separation between two adjacent ones of the layers 132.

Referring again to FIGS. 1A-1E, in an example, the dielectric material of the layers 132 has relatively high permeability in the frequency range of interest. In an example, the dielectric material of the layers 132 has a relative magnetic permeability μᵣ of at least 1.5, or at least 1.8, or at least 2, or at least 2.5, or at least 3, or at least 5, or at least 7, or at least 10, or at least 12, e.g., for the frequency range of interest (which may be about 10 MHz to about 1 GHZ, for example). In an example, the dielectric material of the layers 132 has a magnetic loss tangent of at most 1.5, or at most 1.2, or at most 1, or at most 0.9, or at most 0.75, or at most 0.6, or at most 0.5, e.g., for the frequency range of interest (which may be about 10 MHz to about 1 GHZ, for example). Any appropriate dielectric material having the above described relatively high relative magnetic permeability may be used, such as commercially available WaveX® sheets of dielectric material, although other appropriate dielectric materials may also be used.

In an example, such a relatively high permeability of the dielectric material of the layers 132 facilitates in reducing a volume of the lower cavity 104, without substantially sacrificing parameters of interest (such as gain and bandwidth) of the antenna 100. For example, without the layers 132 present within the lower cavity 104, the volume (and resultantly dimensions in the X, Y, and/or Z axes directions) of the lower cavity 104 may have to be relatively larger, e.g., to achieve the desired parameters of interest. However, in an example, introducing a relatively high relative magnetic permeability material, such as the layers 132, within the lower cavity 104 allows to reduce the volume of the lower cavity 104, without substantially sacrificing the parameters of interest (such as gain and bandwidth). Similarly, such a relatively low dielectric constant of the dielectric material of the layers 134 allows to reduce the volume of the lower cavity 104, without substantially sacrificing parameters of interest (such as gain and bandwidth) of the antenna 100. Thus, use of the layers 132, interleaved with the layers 134, allows to make the antenna structure 100 smaller and/or lighter, without substantially sacrificing parameters of interest (such as gain and bandwidth) of the antenna 100.

FIG. 4 illustrates the cavity backed dipole antenna structure 100 of FIGS. 1A-1E, with a dielectric spacer 204 between the upper layer of dielectric material 150 and the conductive structures 122 comprising the dipole arms, in accordance with an embodiment of the present disclosure. In an example, the dielectric spacer 204 ensures a minimum vertical height of the upper cavity 108.

### Method of Manufacturing

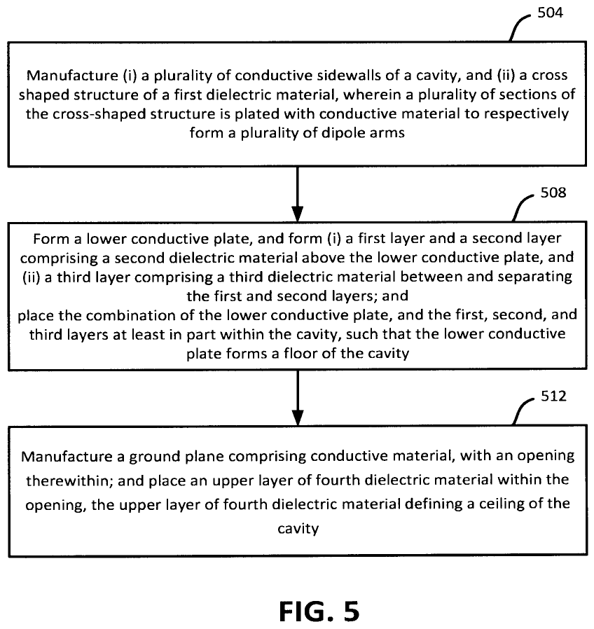

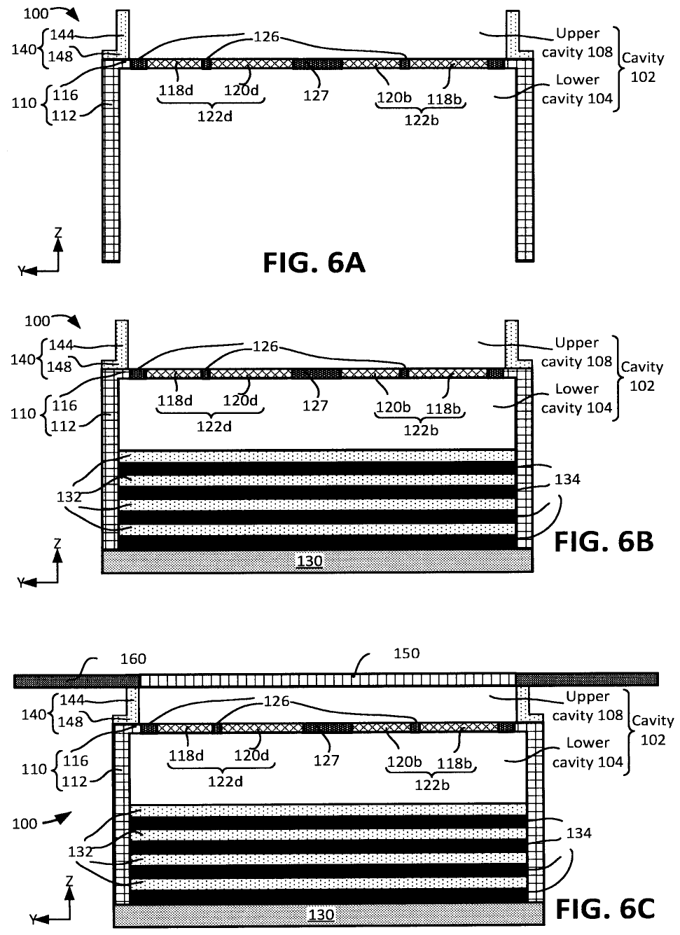

FIG. 5 illustrate a flowchart depicting a method 500 of forming an example a cavity backed dipole antenna structure (such as any of the antenna assemblies described above), in accordance with an embodiment of the present disclosure. FIGS. 6A, 6B, and 6C collectively illustrate an example antenna assembly 100 in various stages of processing in accordance with the methodology 500 of FIG. 5, in accordance with an embodiment of the present disclosure. FIGS. 5 and 6A-6C will be discussed in unison.

The method 500 comprises, at 504, manufacturing (i) a plurality of conductive sidewalls 112, 144 of a cavity 102, and (ii) a cross-shaped structure (e.g., the structure comprising the dielectric materials 126, 127, and inner core of the dipole arms 118, 120) of a first dielectric material. In an example, the cross-shaped structure extends from a first conductive sidewall to an opposing second conductive sidewall, and also from a third conductive sidewall to an opposing fourth conductive sidewall, as illustrated in FIG. 6A, also see FIG. 1F. In an example, a plurality of sections of the cross-shaped structure of the first dielectric material is covered, such as plated, with conductive material, to respectively form a plurality of dipole arms 118a, 118b, 118c, 118d, 120a, 120b, 120c, 120d, some of which are illustrated in the cross-sectional view of FIG. 6A (also see FIG. 1F). Thus, at 504, the structures 110 and 140 are manufactured, along with the dipole arms 118, 120.

Any appropriate manufacturing technique may be employed at process 504. In one example, the structures 110, 140 may be manufactured using an additive manufacturing process, although other manufacturing techniques may also be used. For example, additively manufacturing the structures 110, 140 may include printing the structures 110, 140 using a three dimensional (3D) printing process. Additive manufacturing, such as 3D printing, uses computer-aided-design (CAD) software and/or 3D object scanners to direct hardware to deposit material, layer upon layer, in precise geometric shapes. As its name implies, additive manufacturing adds material to create an object. Thus, additive manufacturing involves a computer controlled process that creates 3D objects, such as the structures 110, 140, by depositing materials, usually in layers. In an example, the cross-shaped structure of dielectric material may also be additively manufactured.

In an example where the structures 110, 140 are additively manufactured, the structures 110, 140 are continuous and monolithic, and comprises a conductive material, such as one or more metals and/or alloys thereof (or a non-metal coated by a metal). The structures 110, 140 being a monolithic and continuous implies that any section of the structures 110, 140 is conjoined (e.g., physically joined) with any other section of the structures 110, 140 via one or more intervening sections, without an interface (such as a seam) therebetween. Thus, the combination of the structures 110, 140 is a single integral conductive structure that has been additively manufactured, in an example.

The method 500 proceeds from 504 to 508. At 508, a lower conductive plate 130 is formed, and also formed are (i) a first layer and a second layer (e.g., two instances of the layers 132) comprising a second dielectric material above the lower conductive plate 130, and (ii) a third layer (e.g., layer 134) comprising a third dielectric material between and separating the first and second layers. Subsequently, the combination of the lower conductive plate 130, and the first, second, and third layers 132, 134 are placed at least in part within the cavity 104, such that the lower conductive plate 130 forms a floor of the cavity 104, as illustrated in FIG. 6B. In an example, the second dielectric material is compositionally different from the third dielectric material. The dielectric materials of the layers 132, 134 have been described in detail above. In an example, the conductive plate 130, with the layers 132, 134 formed thereon, is attached to the lower surface of the vertical walls 112 of the structure 110.

The method 500 proceeds from 508 to 512. At 512, a ground plane 160 comprising conductive material is manufactured, with an opening therewithin; and an upper layer 150 comprising fourth dielectric material is placed within the opening, as illustrated in FIG. 6C. The upper layer comprising fourth dielectric material defines a ceiling of the cavity 102.

Note that the processes in method 500 are shown in a particular order for ease of description. However, one or more of the processes may be performed in a different order or may not be performed at all (and thus be optional), in accordance with some embodiments. For example, process 508 may be performed after (or at least in part concurrently with) process 512. Numerous variations of method 500 and the techniques described herein will be apparent in light of this disclosure.

### FURTHER EXAMPLE EXAMPLES

The following examples pertain to further examples, from which numerous permutations and configurations will be apparent.

Example 1. A cavity backed antenna assembly comprising: a conductive lower wall and two or more conductive side walls at least in part defining a cavity; a first layer and a second layer each comprising a first dielectric material above the conductive lower wall and within the cavity; a third layer comprising a second dielectric material between and separating the first and second layers, the second dielectric material compositionally different from the first dielectric material; and a first conductive structure and a second conductive structure separated by a third dielectric material, wherein the first conductive structure and the second conductive structure are within the cavity and above the first and second layers.

Example 2. The cavity backed antenna assembly of example 1, wherein the first dielectric material has a relative magnetic permeability of at least 1 for a frequency between 10 MHz and 1 GHz.

Example 3. The cavity backed antenna assembly of any one of examples 1-2, wherein the first dielectric material has a magnetic loss tangent of at most 1 for a frequency between 10 MHz and 1 GHZ.

Example 4. The cavity backed antenna assembly of any one of examples 1-3, wherein the second dielectric material has a dielectric constant of at most 1.5.

Example 5. The cavity backed antenna assembly of any one of examples 1-4, wherein: the two or more conductive side walls comprises a first conductive sidewall, a second conductive sidewall, a third conductive sidewall, and a fourth conductive sidewall; and one or both the first and second layers of the first dielectric material has a cross-shaped structure that extends from the first conductive sidewall to the second conductive sidewall opposite the first conductive sidewall, and also from the third conductive sidewall to the fourth conductive sidewall opposite the third conductive sidewall.

Example 6. The cavity backed antenna assembly of any one of examples 1-5, wherein: the two or more conductive side walls comprises a first conductive sidewall, a second conductive sidewall, a third conductive sidewall, and a fourth conductive sidewall; and one or both the first and second layers of the first dielectric material has a rectangular structure that extends from the first conductive sidewall to the second conductive sidewall opposite the first conductive sidewall, and also from the third conductive sidewall to the fourth conductive sidewall opposite the third conductive sidewall.

Example 7. The cavity backed antenna assembly of any one of examples 1-6, wherein: the first layer or second layer is completely within a portion of the cavity; the portion of the cavity has a maximum length, a maximum width, and a maximum cross-sectional area based on the maximum length and maximum width; and the first layer or second layer occupies only a portion of the maximum cross-sectional area.

Example 7a. The cavity backed antenna assembly of example 7, wherein the first layer or second layer occupies 50% to 75% of the maximum cross-sectional area.

Example 7b. The cavity backed antenna assembly of any one of examples 7-7a, wherein: both the first layer and second layer are completely within a corresponding portion of the cavity; each corresponding portion of the cavity has a maximum length, a maximum width, and a maximum cross-sectional area based on the maximum length and maximum width; and each of the first layer and second layer occupies only a portion of the corresponding maximum cross-sectional area.

Example 7c. The cavity backed antenna assembly of any one of examples 1-7b, wherein: the cavity has a cross-sectional area; the first layer or the second layer is shaped to reduce the amount of the cross-sectional area it occupies.

Example 8. The cavity backed antenna assembly of any one of examples 1-7c, further comprising: a plurality of conductive structures that includes the first and second conductive structures, and that extends from a first conductive sidewall to an opposing second conductive sidewall, wherein any the first plurality of conductive structures is separated from an adjacent one of the first plurality of conductive structures and/or any of the conductive sidewalls by corresponding a corresponding section of the third dielectric material.

Example 9. The cavity backed antenna assembly of example 8, wherein the plurality of conductive structures comprises a first plurality of conductive structures, and wherein the cavity backed antenna assembly further comprises: a second plurality of conductive structures that extends from a third conductive sidewall to an opposing fourth conductive sidewall, wherein any the second plurality of conductive structures is separated from an adjacent one of the first or second plurality of conductive structures and/or any of the conductive sidewalls by a corresponding section of the third dielectric material.

Example 10. The cavity backed antenna assembly of any one of examples 8-9, wherein: the third dielectric material forms a cross-shaped structure extending from the first conductive sidewall to the opposing second conductive sidewall, and also from the third conductive sidewall to the opposing fourth conductive sidewall; and portions of the cross-shaped structure are plated with conductive material, to form the first plurality of conductive structures and the second plurality of conductive structures.

Example 11. The cavity backed antenna assembly of any one of examples 8-10, further comprising: a plurality of feed lines, each feed line of the plurality of feed lines in contact with a corresponding one of the plurality of conductive structures, wherein the plurality of conductive structures forms a corresponding plurality of dipole arms of the cavity backed antenna assembly.

Example 12. The cavity backed antenna assembly of any one of examples 1-11, further comprising: a ground plane comprising conductive material, the ground plane having an opening therewithin; and an upper layer comprising a fourth dielectric material extending through the opening within the ground plane, the upper layer defining a ceiling of the cavity.

Example 13. The cavity backed antenna assembly of example 12, wherein the upper layer is a radome of the cavity backed antenna assembly.

Example 14. The cavity backed antenna assembly of any one of examples 1-13, wherein the second dielectric material is a dielectric foam material.

Example 15. A method of manufacturing an antenna assembly, the method comprising: manufacturing (i) a plurality of conductive sidewalls of a cavity, and (ii) a cross-shaped structure comprising a first dielectric material that extends from a first conductive sidewall to an opposing second conductive sidewall, and also from a third conductive sidewall to an opposing fourth conductive sidewall, wherein a plurality of sections of the cross-shaped structure is plated with conductive material to respectively form a plurality of dipole arms; forming (i) a lower conductive plate, (ii) a first layer and a second layer comprising a second dielectric material above the lower conductive plate, and (iii) a third layer comprising a third dielectric material between and separating the first and second layers, the second dielectric material compositionally different from the third dielectric material; and placing the lower conductive plate, the first layer, the second layer, and the third layer at least in part within the cavity, such that the lower conductive plate forms a floor of the cavity.

Example 16. The method of example 15, further comprising: manufacturing a ground plane comprising conductive material, with an opening therewithin; and placing an upper layer comprising fourth dielectric material within the opening, the upper layer of fourth dielectric material defining a ceiling of the cavity.

Example 17. The method of any one of examples 15-16, wherein manufacturing the plurality of conductive sidewalls and the ground plane comprises manufacturing, using a three-dimensional (3D) printing process, the plurality of conductive sidewalls of the cavity and/or the ground plane.

Example 18. An antenna assembly comprising: a conductive ground plane, with an opening therewithin; an upper layer comprising first dielectric material extending within the opening, and defining a ceiling of a cavity; a plurality of conductive plates defining a corresponding plurality of sidewalls of the cavity; a lower conductive plate defining a floor of the cavity; and a layer comprising second dielectric material above the lower conductive plate, and extending from a first sidewall to an opposing second sidewall of the cavity, the layer of dielectric material having a relative magnetic permeability of at least 1 for a frequency between 10 MHz and 1 GHZ.

Example 19. The antenna assembly of example 18, further comprising: a first plurality of dipole arms above the layer comprising the second dielectric material, the first plurality of dipole arms extending from the first sidewall to the opposing second sidewall, where each dipole arm of the first plurality of dipole arms is separated from an adjacent one of the first plurality of dipole arms or from any of plurality of sidewalls by corresponding a corresponding section of a third dielectric material; and a second plurality of dipole arms above the layer comprising the second dielectric material, the second plurality of dipole arms extending from a third sidewall of the cavity to an opposing fourth sidewall of the cavity, where each dipole arm of the second plurality of dipole arms is separated from an adjacent one of the first or second plurality of dipole arms or from any of plurality of sidewalls by a corresponding section of the third dielectric material.

Example 20. The antenna assembly of any one of examples 18-19, wherein the layer comprising the second dielectric material is a first layer, and wherein the antenna assembly further comprises: a second layer comprising the second dielectric material above the lower conductive plate, stacked above the first layer comprising the second dielectric material, and separated from the first layer comprising the second dielectric material by a fourth dielectric material.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the antenna assembly described above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A cavity backed antenna assembly comprising:
a conductive lower wall and two or more conductive side walls at least in part defining a cavity;
a first layer and a second layer each comprising a first dielectric material above the conductive lower wall and within the cavity;
a third layer comprising a second dielectric material between and separating the first and second layers, the second dielectric material compositionally different from the first dielectric material; and
a first conductive structure and a second conductive structure separated by a third dielectric material, wherein the first conductive structure and the second conductive structure are within the cavity and above the first and second layers.

2. The cavity backed antenna assembly of claim 1, wherein the first dielectric material has a relative magnetic permeability of at least 1 for a frequency between 10 MHz and 1 GHz.

3. The cavity backed antenna assembly of claim 1, wherein the first dielectric material has a magnetic loss tangent of at most 1 for a frequency between 10 MHz and 1 GHz.

4. The cavity backed antenna assembly of claim 1, wherein the second dielectric material has a dielectric constant of at most 1.5.

5. The cavity backed antenna assembly of claim 1, wherein:
the two or more conductive side walls comprises a first conductive sidewall, a second conductive sidewall, a third conductive sidewall, and a fourth conductive sidewall; and
one or both the first and second layers of the first dielectric material has a cross-shaped structure that extends from the first conductive sidewall to the second conductive sidewall opposite the first conductive sidewall, and also from the third conductive sidewall to the fourth conductive sidewall opposite the third conductive sidewall.

6. The cavity backed antenna assembly of claim 1, wherein:
the two or more conductive side walls comprises a first conductive sidewall, a second conductive sidewall, a third conductive sidewall, and a fourth conductive sidewall; and
one or both the first and second layers of the first dielectric material has a rectangular structure that extends from the first conductive sidewall to the second conductive sidewall opposite the first conductive sidewall, and also from the third conductive sidewall to the fourth conductive sidewall opposite the third conductive sidewall.

7. The cavity backed antenna assembly of claim 1, wherein:
the first layer or second layer is completely within a portion of the cavity;
the portion of the cavity has a maximum length, a maximum width, and a maximum cross-sectional area based on the maximum length and maximum width; and
the first layer or second layer occupies only a portion of the maximum cross-sectional area.

8. The cavity backed antenna assembly of claim 7, wherein the first layer or second layer occupies 50% to 75% of the maximum cross-sectional area.

9. The cavity backed antenna assembly of claim 1, further comprising:
a plurality of conductive structures that includes the first and second conductive structures, and that extends from a first conductive sidewall to an opposing second conductive sidewall, wherein any the first plurality of conductive structures is separated from an adjacent one of the first plurality of conductive structures and/or any of the conductive sidewalls by corresponding a corresponding section of the third dielectric material.

10. The cavity backed antenna assembly of claim 9, wherein the plurality of conductive structures comprises a first plurality of conductive structures, and wherein the cavity backed antenna assembly further comprises:
a second plurality of conductive structures that extends from a third conductive sidewall to an opposing fourth conductive sidewall, wherein any the second plurality of conductive structures is separated from an adjacent one of the first or second plurality of conductive structures and/or any of the conductive sidewalls by a corresponding section of the third dielectric material.

11. The cavity backed antenna assembly of claim 9, wherein:
the third dielectric material forms a cross-shaped structure extending from the first conductive sidewall to the opposing second conductive sidewall, and also from the third conductive sidewall to the opposing fourth conductive sidewall; and
portions of the cross-shaped structure are plated with conductive material, to form the first plurality of conductive structures and the second plurality of conductive structures.

12. The cavity backed antenna assembly of claim 9, further comprising:
a plurality of feed lines, each feed line of the plurality of feed lines in contact with a corresponding one of the plurality of conductive structures,
wherein the plurality of conductive structures forms a corresponding plurality of dipole arms of the cavity backed antenna assembly.

13. The cavity backed antenna assembly of claim 1, further comprising:
a ground plane comprising conductive material, the ground plane having an opening therewithin; and
an upper layer comprising a fourth dielectric material extending through the opening within the ground plane, the upper layer defining a ceiling of the cavity, wherein the upper layer is a radome of the cavity backed antenna assembly.

14. The cavity backed antenna assembly of claim 1, wherein the second dielectric material is a dielectric foam material.

15. A method of manufacturing an antenna assembly, the method comprising:
manufacturing (i) a plurality of conductive sidewalls of a cavity, and (ii) a cross-shaped structure comprising a first dielectric material that extends from a first conductive sidewall to an opposing second conductive sidewall, and also from a third conductive sidewall to an opposing fourth conductive sidewall, wherein a plurality of sections of the cross-shaped structure is plated with conductive material to respectively form a plurality of dipole arms;
forming (i) a lower conductive plate, (ii) a first layer and a second layer comprising a second dielectric material above the lower conductive plate, and (iii) a third layer comprising a third dielectric material between and separating the first and second layers, the second dielectric material compositionally different from the third dielectric material; and
placing the lower conductive plate, the first layer, the second layer, and the third layer at least in part within the cavity, such that the lower conductive plate forms a floor of the cavity.

16. The method of claim 15, further comprising:
manufacturing a ground plane comprising conductive material, with an opening therewithin; and
placing an upper layer comprising fourth dielectric material within the opening, the upper layer of fourth dielectric material defining a ceiling of the cavity.

17. The method of claim 15, wherein manufacturing the plurality of conductive sidewalls and the ground plane comprises manufacturing, using a three-dimensional (3D) printing process, the plurality of conductive sidewalls of the cavity and/or the ground plane.

18. An antenna assembly comprising:
a conductive ground plane, with an opening therewithin;
an upper layer comprising first dielectric material extending within the opening, and defining a ceiling of a cavity;
a plurality of conductive plates defining a corresponding plurality of sidewalls of the cavity;
a lower conductive plate defining a floor of the cavity; and
a layer comprising second dielectric material above the lower conductive plate, and extending from a first sidewall to an opposing second sidewall of the cavity, the layer of dielectric material having a relative magnetic permeability of at least 1 for a frequency between 10 MHz and 1 GHz.

19. The antenna assembly of claim 18, further comprising:
a first plurality of dipole arms above the layer comprising the second dielectric material, the first plurality of dipole arms extending from the first sidewall to the opposing second sidewall, where each dipole arm of the first plurality of dipole arms is separated from an adjacent one of the first plurality of dipole arms or from any of plurality of sidewalls by corresponding a corresponding section of a third dielectric material; and
a second plurality of dipole arms above the layer comprising the second dielectric material, the second plurality of dipole arms extending from a third sidewall of the cavity to an opposing fourth sidewall of the cavity, where each dipole arm of the second plurality of dipole arms is separated from an adjacent one of the first or second plurality of dipole arms or from any of plurality of sidewalls by a corresponding section of the third dielectric material.

20. The antenna assembly of claim 18, wherein the layer comprising the second dielectric material is a first layer, and wherein the antenna assembly further comprises:
a second layer comprising the second dielectric material above the lower conductive plate, stacked above the first layer comprising the second dielectric material, and separated from the first layer comprising the second dielectric material by a fourth dielectric material.
